(19) United States
(12) Patent Application Publication
(10) Pub. No.: US 2005/0241492 A1
(43) Pub. Date: Nov. 3, 2005

(54) Deep fat fryer with improved temperature control

(75) Inventors: Klaas Kooyker, Drachten (NL); Andries Bron, Drachten (NL); Mindert Kats, Drachten (NL); Huub Ehlhardt, 's-Hertogenbosch (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/525,474

(22) PCT Filed: Jul. 24, 2003
(86) PCT No.: PCT/IB03/03327

§ 371 Date: Feb. 23, 2005

(30) Foreign Application Priority Data
Aug. 29, 2002 (EP) 02078556.4

(51) Int. Cl. A47J 37/12

(52) U.S. Cl. 99/403

(57) ABSTRACT

A deep fat fryer has a control system (11) connected to a temperature sensor circuit (6) and to a heater control (13) for thermostatically activating a heating element (2) in response to a temperature signal from a temperature sensor circuit (6) representing a temperature at or below a lower limit value and deactivating the heating element (2) in response to a temperature signal representing a temperature at or above an upper limit value. The control system (11) is further adapted for, if the heating element (2) is active, generating the food lowering command signal in response to a temperature signal from the temperature sensor circuit (6) representing a predetermined sensed temperature below the upper limit value.

### BACKGROUND OF THE INVENTION

The present invention relates to a deep fat fryer according to the introductory portion of claim 1.

Such a deep fat fryer is known from U.S. Pat. No. 6,138,552. In this deep fat fryer, the lowering command signal is generated when the selected cooking temperature is reached by the cooking bath and causes a basket lift motor to immerse a basket carrying food to be fried into the fat in the frying pan.

A problem of this and other thermostatically controlled deep fat fryers is that the temperature of the fat sinks for a substantial period of time after a batch of food has been lowered therein. This period of time varies substantially as does the required cooking time for a given quantity of a given food. The thermostatic temperature control will respond to the temperature drop and activate the heating element. However, there is a lag between the time when the food is lowered in the fat causing an immediate temperature drop and the time when the thermostat calls for heat. Subsequently, it also takes some time before the temperature gradient associated to the maximum heat flow from the element to the fat is established. The time lag between the temperature drop and the establishment of the maximum heat flow is normally 45 seconds or more.

The temperature drop has an adverse effect on the fried food quality. The longer the duration of the temperature drop, the more fat is absorbed by the food and the more water is lost from the food.

Another problem of deep fat fryers is that degeneration of the cooking medium is accelerated and energy consumption is increased due to overshoot in the temperature of the cooking medium, which occurs in use.

In U.S. Pat. No. 3,894,483, it is described to overcome the thermostat time reaction lag by initiating burner operation before or as the food is lowered into the cooking medium by either combining a bypass reset timer with a well-known adjustable frying cycle timer or manual start switch, or by tying in the bypass reset and cycle timers with an automatic lowering basket lift, such as that disclosed in U.S. Pat. No. 3,273,488. However, the activation of the heater results in a temperature overshoot if the food to be fried is lowered into the cooking medium too late or if no food has been loaded into the basket. Conversely, if the food is lowered into the cooking medium at the same time as heater operation is initiated or very briefly thereafter, heat flow to the cooking medium may still be building up after the temperature of the cooking medium has dropped or the temperature of the cooking medium, which varies in accordance with the thermostatically controlled activation and deactivation of the heater, may be relatively low at the time of lowering of the food.

Also in U.S. Pat. No. 5,596,514 it is described to provide an “instant-on” feature that causes the heating element to be turned on immediately, regardless of the cooking medium temperature. This feature is activated once a product key is depressed to initiate the cook mode. After a period of 15 seconds, a controller evaluates whether the temperature has gone up or fallen. If the temperature has gone up, the heating element is turned off. If the temperature has fallen, the heating element remains on. Also this solution entails that the activation of the heater can easily result in a temperature overshoot if the food to be fried is lowered into the cooking medium too late (depending on the temperature and the heating condition when the product key is depressed) or if no food is lowered into the cooking medium at all. The food can also be lowered into the cooking medium too early, i.e. before the heat flow to the fat is fully established and/or while the temperature is near the low end of the temperature range maintained by the thermostatic heater control.

### SUMMARY OF THE INVENTION

It is an object of this invention to overcome the reaction lag between the temperature drop associated with the lowering of food in the cooking medium and the establishment of the maximum heat flow from the heater to the cooking medium while avoiding or at least reducing the risk of temperature overshoot due to food not being lowered into the cooking medium in good time.

It is another object of this invention to save on the amount of energy required in a given cooking operation.

These objects are achieved by providing a deep fat fryer according to claim 1. The generation of a food lowering command signal commanding the lowering of food to the cooking medium in response to a temperature signal representing a sensed temperature below the upper limit value of the cooking medium temperature at which the heater is deactivated and while the heating element is active supports optimal timing of the lowering of the food into the cooking medium, so that the temperature drop is minimized while the risk of temperature overshoot is avoided or at least reduced.

Particular embodiments of the invention are set forth in the dependent claims.

Other objects, features and effects as well as details of this invention appear from the detailed description of a preferred form of the invention.

### BRIEF DESCRIPTION OF THE DRAWINGS

FIG. 1 is a schematic representation in side view of a deep fat fryer according to the present invention;

FIG. 2 is a graph of temperature over time of a first example of operation of a deep fat fryer according to the present invention; and

FIG. 3 is a graph of temperature over time of a second example of operation of a deep fat fryer according to the present invention.

### DETAILED DESCRIPTION

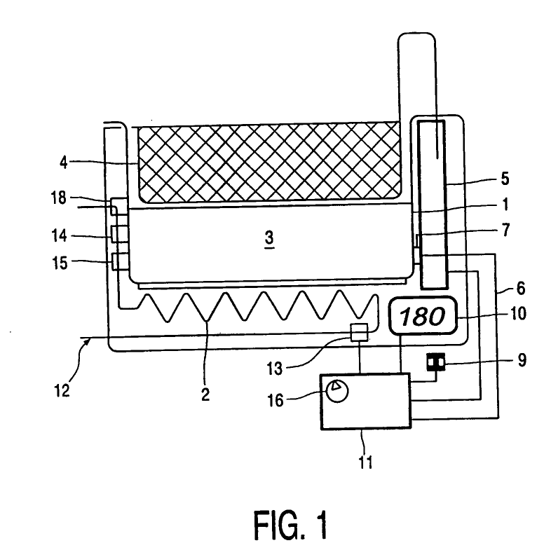

In FIG. 1 an example of a deep fat fryer according to the invention is shown which includes a removable frying pan 1 and a heating element 2 for heating a cooking medium 3 (usually frying fat) in the frying pan 1. To lower food into the cooking medium 3 and to lift food out of the cooking medium 3 a basket 4 and an automated basket lift 5 are provided.

A temperature sensor circuit 6 is provided for sensing the temperature of the cooking medium 3 in the frying pan 1 and for generating a temperature signal representing the sensed temperature in the frying pan 1. The temperature sensor circuit 6 includes a negative temperature coefficient probe 7 as is well known in the art.

A sound generator 9 in the form of a buzzer connected to the control system 11 is provided. The control system 11 is adapted for outputting a food lowering command signal to the buzzer 9, which causes the buzzer 9 to generate an audible food lowering command signal warning the user that the food should be lowered into the basket 4 in preparation of the lowering into the fat 3. Alternatively, or additionally, also other sound generators, such as beepers and loudspeakers connected to circuitry for generating signals driving the loudspeaker can be provided. Furthermore, the fryer is equipped with a display 10 that may be used to show optical command signals and other information, such as the temperature setting. The control system 11 is further adapted for generating further food lowering command signals, controlling the automated basket lift 5 to further lower the food into the fat 3.

The heating element 2 is included in a heating circuit 12 which includes a heating element control switch 13 for switching the heating element 2 on and off to control of the temperature of the cooking medium 3 by activating and deactivating the heater 2. The heating circuit 12 further includes a number of safety features in the form of a pan presence sensor 18, a thermostatic switch 14 that opens in response to a temperature exceeding the maximum allowable frying temperature and automatically closes when the temperature is lowered again to a level under the maximum allowable frying temperature and a safety fuse 15 adapted to open in response to a highest safe temperature above the maximum allowable frying temperature.

The temperature sensor circuit 6 and the control switch 13 are operatively connected to the electronic control system 1 1, which is adapted for thermostatically controlling the switch 13 for activating the heating element 2 in response to a temperature signal from the temperature sensor circuit 6 representing a sensed temperature at or below a lower limit value and deactivating the heating element 2 in response to a temperature signal from the temperature sensor circuit 6 representing a sensed temperature at or above an upper limit value.

Thus, the control system 11 generates a food lowering command signal commanding the lowering of food into the basket 4 in preparation of the lowering of food into the cooking medium 3 and for generating a food lowering command signal causing the basket 4 carrying the food to be lowered into the fat 3 in response to at least one temperature signal that represents a given sensed temperature below the upper limit value to which the control system 11 is set. The control system 11 is further adapted to only generate food lowering command signals if the heating element 2 is active.

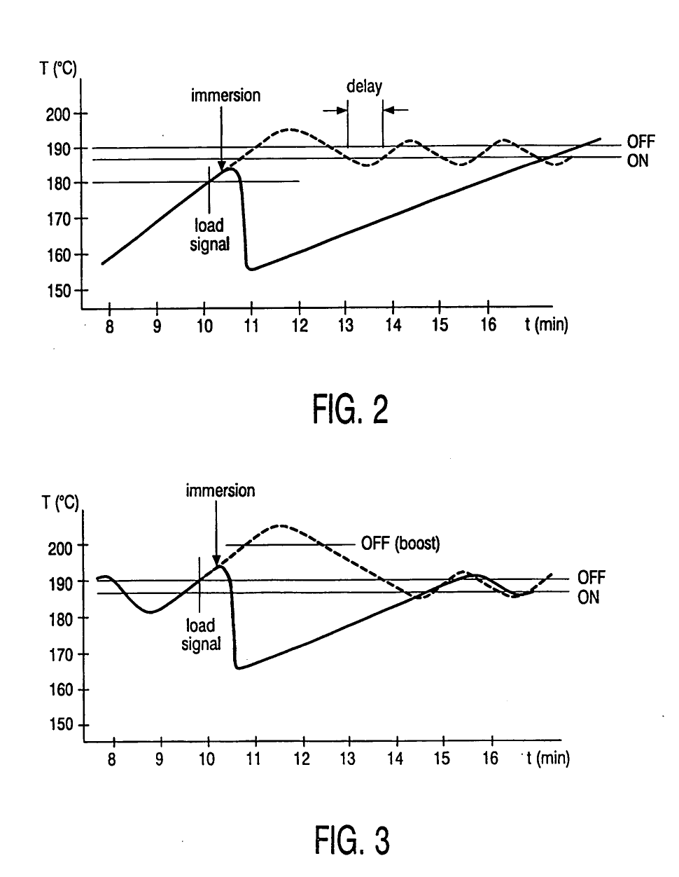

A first example of the operation of the described fryer is described with reference to the graph shown in FIG. 2. The continuous line in the graph in FIG. 2 represents the cooking medium temperature over time after the fryer is switched on and if food is immersed into the cooking medium after approximately 10 min 30 s. The food immersion may be completely or partially. The interrupted line shows the cooking medium temperature over time if no food is immersed into the cooking medium 3.

First, the temperature rises while the heating element 2 is active. In the present example, the control system 11 is set via a user interface 16 in the form of a control knob to a set point temperature (upper limit value) of 190° C. at which the heating element 2 is turned off. In this example, the associated turn-on temperature (lower limit value) at and below which the heating element 2 is switched on is 186° C. A first food lowering command signal—in the graph designated as “load signal”—is generated in response to a first occurrence after switching on of the fryer or after warming up of the cooking medium 3 from a temperature below the frying range (for instance from a temperature of 100° C. or lower) of a temperature signal representing a sensed temperature 10° C. below the pre-set upper limit value (in this example 190° C.) at which the heater 2 is switched off during frying at the selected temperature setting. This “load signal” warns the user that—if not already loaded into the basket 4—food should be placed in the basket 4 in preparation of the imminent lowering of the basket 4 into the cooking medium 3.

A second food lowering command signal—in the graph designated as “immersion”—is generated in response to a first occurrence after switching on of the fryer or after warming up of the cooking medium 3 from a temperature below the frying range (for instance from a temperature of 100° C. or lower) of a temperature signal representing a sensed temperature 5° C. below the upper limit value of a pre-set temperature (in this example 190° C.) at which the heater 2 is switched off during frying at the selected temperature setting. This “immersion” signal causes the basket lift 5 to lower the basket 4 carrying the food into the cooking medium 3.

Then, according to this example, at t=10 min 30 s, the immersion of the food into the cooking medium 3 causes the temperature of the cooking medium 3 to drop to approximately 155° C. Because the heat flow from the heating element 2 to the cooking medium 3 is already fully established, after the temperature drop, the temperature of the cooking medium 3 virtually immediately starts to rise back to the pre-set temperature, without the normal delay between passage of the switch-on temperature and establishment of the full heat flow. In FIG. 2, the duration of this normal delay between passage of the switch-on temperature and establishment of the full heat flow is in the idle situation represented by the interrupted line appears from the time span designated as “delay”.

Because the signals to load the basket 4 and to lower the basket 4 are given in response to temperature signals representing a sensed temperature lower than the maximum temperature at which the heater is active at the selected temperature setting, the risk of temperature overshoot is reduced, while it is at the same time ensured that the heat flow from the heater 2 to the cooking medium 3 is not interrupted before the temperature drop and needs to be built up again while and after the temperature drop has occurred. Furthermore, it is ensured that the temperature of the cooking medium 3 is not far below the upper limit value when the food is lowered into the cooking medium 3.

The control system 11 is adapted to cause to generate the signal to load the basket 4 and to generate the signal to lower the basket 4 in response to temperature signals representing sensed temperatures below the pre-set temperature only upon the first occurrence of the respective temperature signals. Thus, it is avoided that the signals to lower food into the basket 4 and to lower the basket 4 are repeated when the temperatures of 180° C. and 185° C. are reached again while the food is being fried. This can for instance be achieved by deactivating the generations of the basket lowering command signals in response to these sensed temperatures 120 seconds after the respective signals have been generated.

Because the temperature of the cooking medium 3 rises quickly after the drop associated with the immersion of the food to be cooked, the amount of fat absorbed in the food is kept relatively low, drying out of the food is limited and the formation of excessive crust thickness is avoided. Because the frying time is not prolonged due to the thermostatic response time, food can be cooked in small portions without each time having to go through the thermostatic response time. Cooking in smaller portions further reduces the temperature drop and further reduces the time required to reach the upper limit value of the temperature of the cooking medium 3 after the temperature. drop. Accordingly, the quality of the food can be further improved by cooking in small portions without requiring much more time.

It is observed that the temperatures described in the present example can also be chosen differently. Also, the differences between the upper limit value of the sensed temperature and the predetermined sensed temperatures in response to which the food lowering command signals are given need not be fixed. It is for instance possible to determine the temperature in response to which a food lowering command signal is given from the steepness of the temperature rise over time and the desired time between the signal and the moment when the upper limit value of the sensed temperature would be reached if no food is lowered into the cooking medium. Then, the food lowering command signal can be given a predetermined (and optionally adjustable) amount of time before the pre-set upper limit value of the temperature would be reached independently of the steepness of the temperature rise during heating of the cooking medium.

In FIG. 3, a second example of operation of the described deep fat fryer is shown. According to this example, the user interface 16 has been operated briefly after t=9 min to bring the control system 11 in a boost condition controlling the heater 2 to be active to a temporarily increased upper limit value of the cooking medium temperature (in this example 200° C.) above the pre-set upper limit value of the sensed temperature (in this example 190° C.).

Approximately at t=10 min, the control system 11 generates the “load signal” activating the buzzer 9 in response to a sensed temperature 10° C. below the temporarily increased upper limit value of the cooking medium temperature at which the heating element 2 is or would be deactivated if no food is lowered into the cooking medium. Approximately at t=10 min 45 s, the food immersion command signal causing the basket 4 to be lowered is generated in response to a temperature signal representing a sensed temperature 4° C. below the temporarily increased maximum temperature at which the heater 2 is active when the control system 11 is in boost condition at the selected temperature setting. As in the previous example, it is ensured that the heat flow from the heating element 2 to the cooking medium 3 is already fully established and not switched off again when the food is immersed (partially or completely) in the cooking medium 3. Accordingly, after the temperature drop, the temperature virtually immediately starts to rise back to the pre-set temperature, without a delay due to the response time of the thermostat and the time required to establish the temperature gradient associated to the maximum heat flow from the heater 2 to the cooking medium 3.

Again, the food lowering command signals warning the user to load food into the basket 4 and controlling the lift 5 to lower the basket 4 are given before the heater deactivation temperature that is in force has been reached, so that the risk of temperature overshoot is reduced.

It is observed that the temporary temperature increase caused by the temporarily increased upper limit value at which the heater is deactivated may indeed cause a slightly accelerated degradation of the cooking medium. However, this effect is small, especially if, as is intended, food is lowered into the cooking medium before the temporarily increased upper limit value of the cooking medium temperature is reached. Furthermore, a higher cooking medium temperature at the time food is lowered into the cooking medium results in a quicker heat transfer to the food. This in turn results in a reduced fat absorption and a shorter cooking time.

The temporary increase of the upper limit value of the cooking medium temperature at which the heater 2 is deactivated further allows to ensure that the heater 2 is activated for a sufficiently long period of time to establish full heat flow from the heater 2 to the cooking medium 3 even if the cooking medium temperature is at its maximum within the range associated to the selected temperature setting when the boost condition is activated. To reliably achieve this effect, the temporary increase of the upper limit value is preferably at least 5 to 10° C.

In fryers which are not equipped with an automatic basket lift or which are not equipped with a powered basket lift at all so that the basket must be lowered and lifted manually, the food lowering command signal may for instance consist solely of a human perceptible signal (preferably a sound signal) indicating that it is time to lower the basket carrying food into the cooking medium or of a first human perceptible signal warning that the basket should be loaded and a second human perceptible signal indicating that the basket should be lowered.

The increased upper limit value of the temperature at which the heater 2 is deactivated when the control system 11 is in boost condition can be determined as a separate limit value for the signal representing the sensed temperature. However, it is also possible to determine that temperature indirectly by setting a predetermined maximum duration of the boost condition which, taking into account the power of the heater 2 and the thermal capacity of the cooking medium 3 and the pan 1, provides a predetermined approximate temperature rise if no food is lowered into the cooking medium. This provides the advantage that a single control parameter is sufficient to limit both the maximum temperature in the boost condition and the duration of the boost condition. Furthermore, the duration of activation of the heater 2 is ensured independently of the current cooking medium temperature at the time the boost condition is initiated.

If the maximum temperature of the boost condition is controlled by setting a temporarily increased limit value for the signal representing the sensed temperature at which the heater 2 is deactivated, this increased limit value is preferably determined by adding a predetermined increase to the pre-set upper limit value of the sensed temperature applicable during frying. The maximum temperature achievable in the boost condition is then closely related to the pre-set frying temperature. The duration of the boost condition can then be limited in a simple manner by ending the boost condition in response to a temperature signal representing that increased upper limit value or in response to the expiry of a predetermined time-interval after initiation of the boost condition. Unnecessary repetition of the food lowering command signals after the food has been lowered into the cooking medium can be avoided by adapting the control system 11 to generate food lowering command signals in response to predetermined temperature signals associated with the boost condition only if the control system 11 is in boost condition. In addition, the control system 11 is preferably adapted to end the boost condition early enough to avoid that the normal upper limit value of the cooking medium associated to the temperature setting that is in force is reached again after the temperature drop caused by the lowering of the food into the cooking medium before the boost condition has ended.

In order to avoid unnecessary repetition of the food lowering command signal or signals, it can be provided that the temperatures in response to which these signals are generated by the control system 11 are not reached when the control system 11 is not in boost condition and before the boost condition has ended after lowering of the food into the cooking medium 3. Alternatively, for the same purpose, it can be provided that the food lowering command signal or signals are generated by the control system 11 in response to temperatures or a temperature associated to the boost condition only if the control system 11 is in boost condition and that the boost condition is ended early enough to prevent that, after lowering of the food into the cooking medium 3, the temperatures or temperature in response to which the food lowering command signals are generated if the control system is in the boost condition are reached again before the boost condition has been ended. Yet another alternative solution to prevent unwanted repetition of food lowering command signals is to adapt the control system 11 to generate the food lowering command signal or signals only once in response to the predetermined temperature or respective temperatures after each activation of the boost condition. The food lowering command signal or signals may each include a plurality of successive stimuli, such as sounds or light signals.

1. A deep fat fryer including:
a frying pan;
a heating element for heating a cooking medium in the frying pan;
a temperature sensor circuit for sensing the temperature of the cooking medium in the frying pan and generating a temperature signal representing the sensed temperature in the frying pan;
a heater control for activating and deactivating the heating element; and
a control system operatively connected to the temperature sensor circuit and to the heater control, the control system being adapted for
thermostatically activating the heating element in response to a temperature signal from the temperature sensor circuit representing a sensed temperature at or below a lower limit value and deactivating the heating element in response to a temperature signal from the temperature sensor circuit representing a sensed temperature at or above an upper limit value; and for
in response to a temperature signal from the temperature sensor circuit, generating a food lowering command signal commanding the lowering of food;
characterized in that the control system is adapted for generating the food lowering command signal in response to a temperature signal from the temperature sensor circuit representing a predetermined sensed temperature below said upper limit value, on condition that the heating element is active.

2. A deep fat fryer according to claim 1, wherein the control system is adapted for generating the food lowering command signal in response to a first occurrence of the temperature signal from the temperature sensor circuit representing a predetermined sensed temperature below said upper limit value after switching on of the fryer or after heating up the cooking medium from a temperature below a lowest possible frying temperature.

3. A deep fat fryer according to claim 1, further including a user interface operatively connected to the control system for setting a boost condition in which boost condition said upper limit value of the sensed temperature and said predetermined sensed temperature below said upper limit value are temporarily increased.

4. A deep fat fryer according to claim 3, wherein said control system is adapted for determining said temporarily increased upper value of the sensed temperature by adding a predetermined increase to said upper limit value of the sensed temperature.

5. A deep fat fryer according to claim 4, wherein the control system is adapted for ending the boost condition in response to a temperature signal representing said increased upper limit value.

6. A deep fat fryer according to claim 3, wherein the control system is adapted for ending the boost condition in response to expiry of a predetermined period of time after the start of the boost condition.

7. A deep fat fryer according claim 1, further comprising at least one signal generator adapted for generating a human perceptible food lowering command signal in response to a food lowering command signal from the control system.

8. A deep fat fryer according to claim 7, further including a basket and a basket lift for lowering the basket into the cooking medium in the frying pan and lifting the basket out of the cooking medium, and adapted to lower the basket into the cooking medium in response to a food lowering command signal from the control system, the control system being adapted to generate the food lowering command signal causing the generation of the human perceptible signal before the generation of the food lowering command signal causing the basket lift to lower the basket into the cooking medium.
